(19) United States
(12) Patent Application Publication
(10) Pub. No.: US 2013/0183035 A1
(43) Pub. Date: Jul. 18, 2013

(54) Enhanced PON And Splitter Module And Associated Method

(71) Applicants: Joseph L. Smith, Fuquay Varina, NC (US); Ronald Heron, Rigaud (CA)

(72) Inventors: Joseph L. Smith, Fuquay Varina, NC (US); Ronald Heron, Rigaud (CA)

(21) Appl. No.: 13/692,567

(22) Filed: Dec. 3, 2012

Related U.S. Application Data
(60) Provisional application No. 61/565,621, filed on Dec. 1, 2011.

(51) Int. Cl. H04Q 11/00

(52) U.S. Cl. CPC H04Q 11/0005
USPC 398/48; 398/68

(57) ABSTRACT

A splitter module for a PON (passive optical network) and method of operating same. An IW (interfering wavelength) is selectively distributed and multiplexed with a downstream PON signal. The ONU (optical network unit) measures and reports performance characteristics such as BER (bit error rate). The performance reporting can be used to identify splitter ports associated with particular ONUs.

### CROSS-REFERENCE TO RELATED APPLICATIONS

The present disclosure is related to and claims priority from U.S. Provisional Patent Application Ser. No. 61/565,621, entitled Enhanced Splitter Module Scheme and filed on 1 Dec. 2011, the entire contents of which are incorporated by reference herein.

### TECHNICAL FIELD

The present invention relates generally to the field of passive optical networks and, more particularly, to a splitter module an optical access network that may be employed, for example, to identify port associations with ONUs or other similar devices.

### BACKGROUND

The following abbreviations are herewith defined, at least some of which are referred to within the following description of the state-of-the-art and the present invention.

### AWG Arrayed Waveguide Grating

### BER Bit Error Rate

### CO Central Office

### DWDM Dense Wavelength Division Multiplexing

### FDH Fiber Distribution Hub

### GPON Gigabit PON

### LED Light-Emitting Diode

### MEMS Micro Electro-Mechanical System

### OLT Optical Line Terminal

### ONT Optical Network Terminal

### ONU Optical Network Unit

### PON Passive Optical Network

### WD Wavelength De-multiplexer

### WM Wavelength Multiplexer

A PON (passive optical network) is often employed as an access network or (from a different perspective) as the access portion of a larger communication network. Large communications networks generally have a high-capacity internal or core portion where data or information associated with, for example, television, telephone service, or Internet access is carried across great distances. The core network may also have the ability to interact with other networks to complete telephone calls, enable other two-way or multi-party communications, or request and receive content for delivery to individuals or business subscribers.

The access portion of a communications network, which may also be referred to as an access network, extends from the core or core portion of the network to individual subscribers, such as those associated with a residence or small business location. Access networks may be wireless access, such as a cellular telephone network, or fixed access, such as a PON or cable network. The access network typically though not necessarily ends at a demarcation point on or near the outside of a subscriber premises.

In a PON, as the name implies, optical fibers and interconnecting devices are used for most or all of the communication through the extent of the access network. While only recently it was relatively unusual for an individual residence to be served by an optical fiber, it is now common and may soon become nearly universally available. The basic components of a typical PON are shown in FIG. 1.

FIG. 1 is a simplified schematic diagram illustrating selected components of a typical PON 100 according to the existing art. ONUs (optical network units) 115a through 115n are devices typically found on the outside of subscribers' homes or other premises. The term “ONU” includes what are often referred to as ONTs (optical network terminals). As the ellipsis in FIG. 1 implies, there may be any number of such devices in a PON that are associated with a single optical splitter. In many implementations there are 32 or 64, thought the number can vary as subscribers are dropped or added or the network configuration is altered.

The optical fibers connecting the splitter to the ONTs it serves are generally referred to as access (or “drop”) fibers. The optical splitter is typically located in a street cabinet or similar structure with many other optical splitters (not shown for clarity), each serving their own set of ONUs. Note that an ONU may be a terminal device that serves many subscribers, such as at an apartment building. The term ONT is usually applied to a single-subscriber device. “ONU” now commonly refers to either.

In the exemplary PON 100 of FIG. 1, an OLT (optical line terminal) 105 is located in a CO (central office) where it interfaces directly or indirectly with a core network (not necessarily using optical signals). In this capacity, OLT 105 forms the optical signals for transmission downstream to ONUs 115a through 115n along a feeder fiber to optical splitter 110. Optical splitter 110 is typically a passive device that simply distributes the signal received from OLT 105 to the ONUs it serves. The optical splitter is frequently located in a FDH (fiber distribution hub), for example a street cabinet, with a number of other such devices.

In a typical PON, each ONU is then responsible for selecting the portions of the transmitted signal that are intended for its subscriber and passes them along. Other portions of the transmitted signal are simply discarded.

Upstream transmissions from ONUs 115a through 115n are often transmitted in bursts according to a schedule provided to each ONU. In this way, none of the ONUs 115a through 115n sends upstream transmissions at the same time. In most applications, upstream transmissions are less frequent than those in the downstream direction and so having to wait for an assigned time slot does not affect upstream performance too significantly. Upstream and downstream transmissions are often sent using different wavelengths of light so as not to interfere with each other.

As mentioned above, although FIG. 1 depicts three ONUs, there are often a great many more in communication with the same optical splitter, and there are generally numerous splitters in the FDH. The splitters may also be cascaded, that is, the distribution represented in FIG. 1 may be accomplished by splitting a downstream transmission, the splitting each of the outputs to address even more ONUs. Of course, cascading is not limited to two stages.

For convenience, the term “splitter port” as used herein will usually refer to the output of an optical splitter or series of splitters that is identified with a single ONU. The present invention may be advantageously employed to facilitate the identification of the association and a given splitter port. This is sometimes necessary as the PON networks include a great number of devices, which may be installed or serviced by different technicians, and which may be changed in configuration. This identification is often necessary to confirm which component or components of the FDH are associated with a specific subscriber. In some cases “splitter port” may refer to the output of an intermediate splitter or a similar component, should it become necessary to identify if the component is associated with a particular ONU.

Accordingly, there has been and still is a need to address the aforementioned shortcomings and other shortcomings associated with the installation and maintenance of PON components. These needs and other needs are satisfied by the present invention.

Note that the techniques or schemes described herein as existing or possible are presented as background for the present invention, but no admission is made thereby that these techniques and schemes were heretofore commercialized or known to others besides the inventors.

### SUMMARY

The present invention is directed at a manner of identifying ports associated with receiving devices in a PON (passive optical network). In one aspect, the present invention is a splitter module for a PON (passive optical network) including an optical splitter, an IW (interfering wavelength) distributor, and at least one WM (wavelength multiplexor) optically connected to and downstream of the optical splitter and the IW distributor. In some implementations, the splitter module may also include an IW source, such as a laser or LED (light-emitting diode). Depending on the implementation, the IW distributor may be an AWG (arrayed waveguide grating) or a second optical splitter.

In some embodiments, the splitter module may include one or more optical switches positioned downstream of respective distributer ports. If present, the optical switch may be for example a VOA (variable optical attenuator) or a MEMS (micro electro-mechanical system) switch. Multiple switches may be said to form a switch array. In any case, and especially for switched embodiments, the splitter module may include a power tap for utilizing a portion of a received downstream transmission for active control or switching operations. In this case, a power system including a controller is usually present. The splitter module may also include a WD (wavelength de-multiplexor) optically connected to and upstream of the optical splitter and the IW distributor.

In another aspect, the present invention is an IW module for a PON including program instructions embodied in a non-signal memory device that when executed causes an IW generator to generate an IW transmission and a multiplexor for multiplexing the IW transmission with a downstream PON transmission. The IW module may also include the IW generator, which may be, for example, a tunable laser or a fixed-wavelength laser. The IW module is preferably resident in a CO (central office).

In some embodiments, the IW module may also include a controller for executing program instructions stored on the memory device. An IW table for recording an IW transmission schedule associating IW transmissions with splitter ports is preferably present as well. Finally, the IW module may include program instructions stored on the memory device that when executed compare the IW transmission schedule to at least one received ONU (optical network unit) performance characteristic such as BER (bit error rate) performance.

In yet another aspect, the present invention is a method of identifying splitter ports in a PON including receiving an IW transmission, distributing the IW transmission to at least one WM, and multiplexing the IW transmission with a downstream PON transmission. This method may be perform, for example, in a CO or a splitter module such as one located in the FDH (fiber distribution hub).

In some embodiments, the method also includes generating the IW transmission, and preferably includes receiving at least one ONU performance characteristic such as BER performance. In a preferred embodiment, the method also includes comparing an IW transmission schedule to the at least one received ONU performance characteristic, and associating the at least one ONU performance characteristic with a splitter port.

In some embodiments, the method also includes de-multiplexing a downstream transmission to segregate the IW transmission from a downstream PON transmission, and may include operating a switch array to guide the IW transmission to a selected WM for the multiplexing of the IW transmission with a downstream PON transmission. The method may also include receiving an IW transmission schedule for controlling the operating of the switch array. Finally, the method may include receiving the IW transmission in an ONU and reporting by the ONU of at least one performance characteristic.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating selected components of a typical PON according to the existing art;

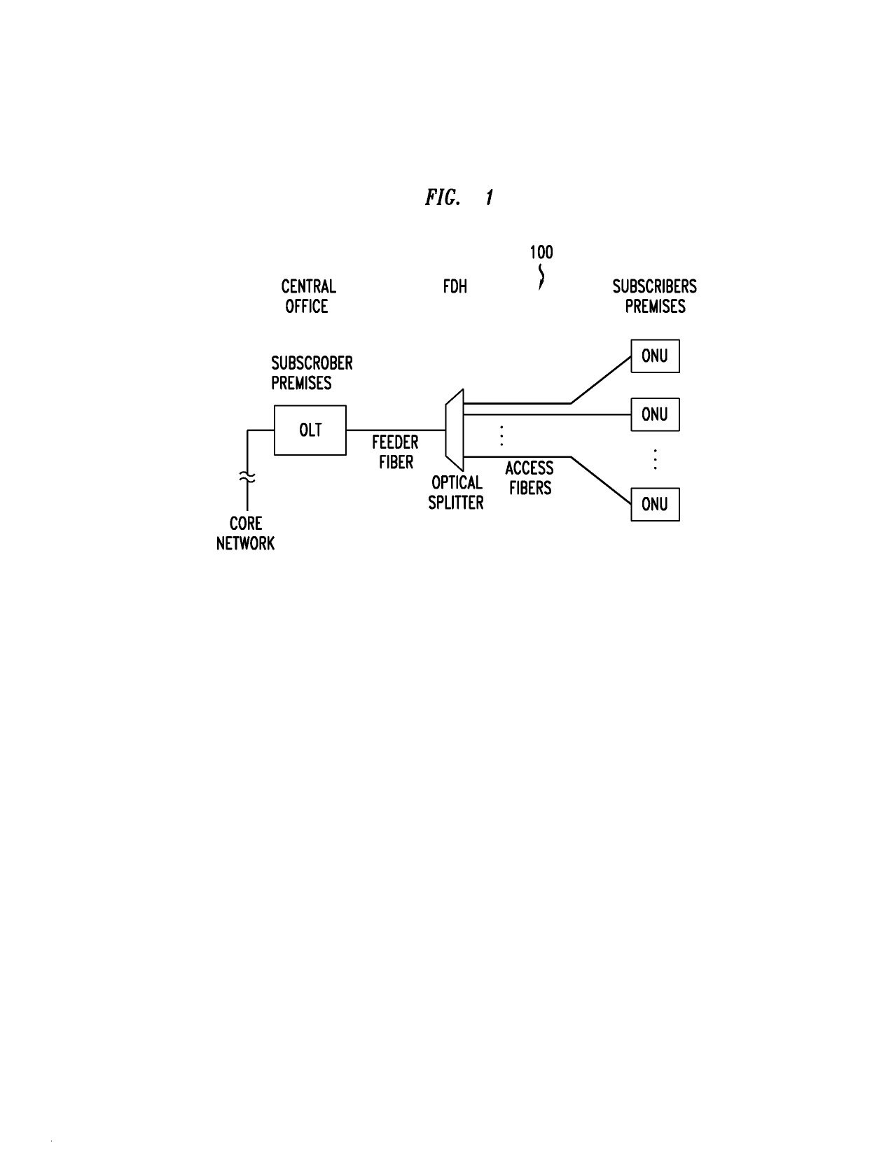

FIG. 2 is a simplified schematic diagram illustrating a central office configuration according to an embodiment of the present invention;

FIG. 3 is a simplified schematic diagram illustrating selected components of a splitter module according to an embodiment of the present invention;

FIG. 4 is a simplified schematic diagram illustrating selected components of the splitter module according to another embodiment of the present invention;

FIG. 5 is a simplified schematic diagram illustrating selected components of the splitter module according to another embodiment of the present invention;

FIG. 6 is a flow diagram illustrating a method according to an embodiment of the present invention; and

FIG. 7 is a flow diagram illustrating a method according to another embodiment of the present invention.

### DETAILED DESCRIPTION

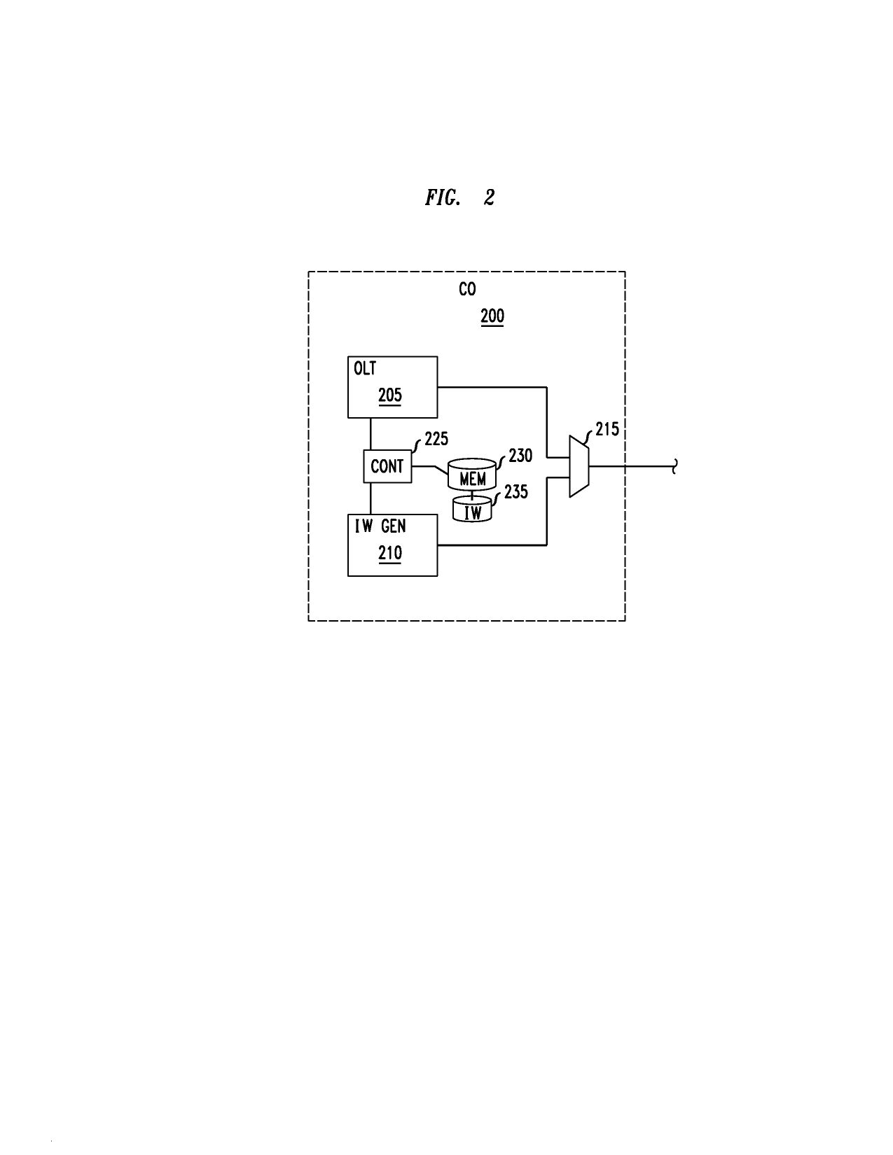

The present invention is directed at a manner of identifying ports associated with receiving devices in a PON (passive optical network). In most implementations this involves identifying splitter ports in the outside plant, such as at an FDH (fiber distribution hub). The present invention will be described in this context, although it uses may vary according to the specific implementation. FIG. 2 is a simplified schematic diagram illustrating a central office 200 configuration according to an embodiment of the present invention.

In the embodiment of FIG. 2, CO (central office) 200 includes an OLT (optical line terminal) 205. OLT 205 is in most implementations one of several such devices in the CO 200, although only one is shown for convenience. OLT 205 is associated with a number of ONUs (optical network units; not shown in FIG. 2), to which it sends downstream PON transmissions (and from which it typically receives upstream transmissions). These downstream PON transmissions may be transmitted, for example, on a wavelength of 1480 to 1500 nm. In accordance with this embodiment, CO 200 also includes an IW (interfering wavelength) generator 210. The IW 210 is in this embodiment associated only with the OLT 205, though a single IW generator may be associated with multiple OLTs in other embodiments.

IW generator 210 may be, for example, any light emitter such as a laser or LED (light emitting diode). In a one embodiment, the IW generator is a fixed wavelength DWDM (dense wavelength division multiplexing) laser. The wavelength emitted is either above or below the operating wavelength used for carrying downstream PON transmissions from the OLT, but within the pass-band for reception at associated ONUs. In an alternate embodiment, the IW generator is tunable to various wavelengths meeting these criteria.

In the embodiment of FIG. 2, the CO 200 also includes a WM (wavelength multiplexor) 215 for multiplexing the IW produced by the IW generator 210 and the downstream PON transmissions generated by the OLT 205. The multiplexed output of the IW transmission and the downstream PON transmission propagates along feeder fiber 220.

In this embodiment, a controller 225 controls the operation of the OLT 205 and the IW generator 210, and in some implementations other components as well. A memory device 230 in communication with the controller 225 is used for storing data and program instructions such as those for implementation of the present invention. The components of central office described above are implemented in hardware or software executing on a hardware device, or a combination of both. Memory device 230 is a non-transitory memory and not a signal unless explicitly recited otherwise in a claimed embodiment. Note that in alternate embodiments, either the controller 225 or memory device 230 or both may be implemented on OLT 205, or outside of the CO.

In the embodiment of FIG. 2, an IW table 235 is present for population with indications of when IW transmissions occur or when they are scheduled to be directed to a selected splitter port or ports. In a preferred embodiment, ONU reception performance, usually as reported by the ONU itself is also stored on the IW table. In one embodiment, for example, ONUs report BER (bit error rate) performance. Ideally, the IW is chosen to produce an increase in BER while not substantially affecting the quality of service to the ONU subscriber or subscribers. The anticipated degradation in BER performance can be matched, for example by controller 225 executing program instructions stored on memory 230, to an IW transmission schedule to determine an associated splitter port.

The IW generator 210, IW table 235, memory 230 including the program instructions, and the WM 215 may be referred to as an IW module according to one embodiment of the present invention. In a preferred embodiment, the IW module includes each of these elements and is resident in the CO.

Finally, note that while in a preferred embodiment, the IW transmission is both generated and multiplexed with the downstream PON transmission in the CO 200; in other embodiments this may occur somewhere in the outside plant.

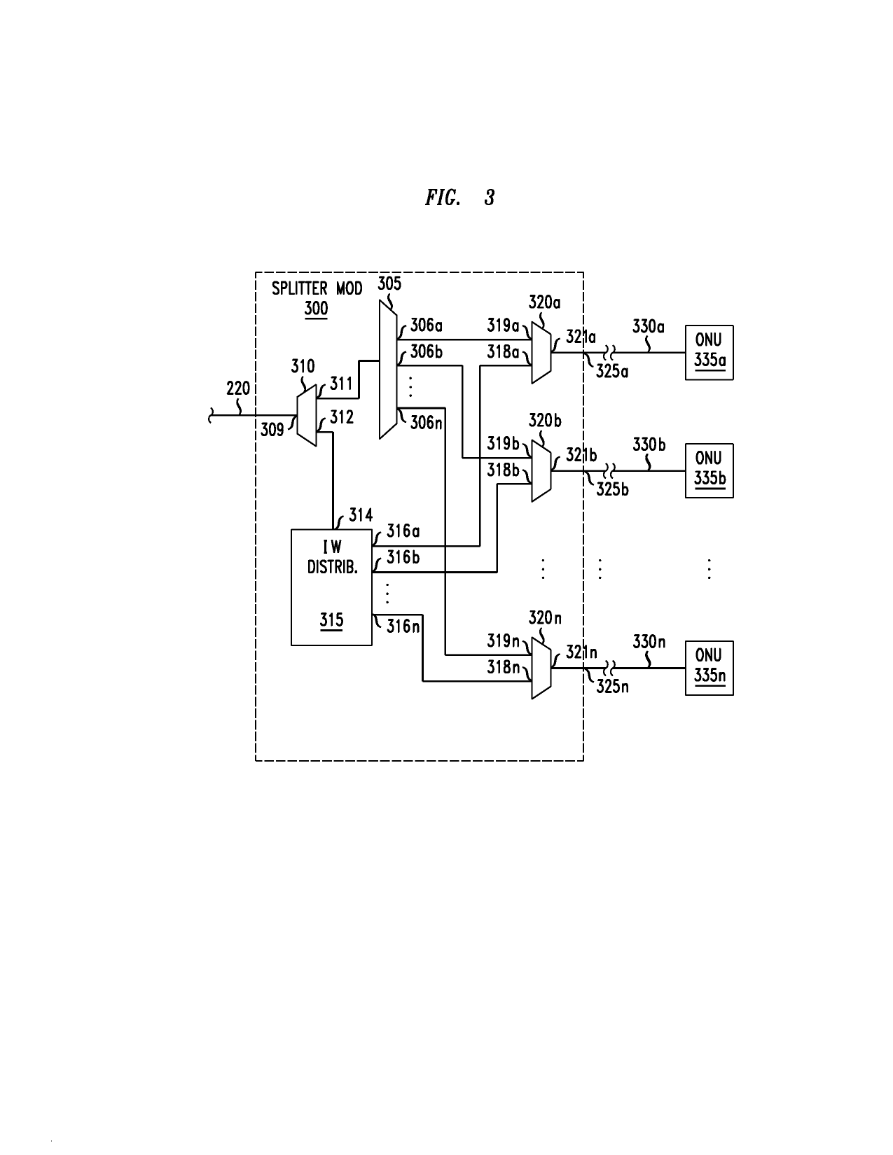

FIG. 3 is a simplified schematic diagram illustrating selected components of a splitter module 300 according to an embodiment of the present invention. In this embodiment, optical splitter module 300 includes a PON splitter 305 that distributes the downstream PON transmission to the individual access fibers connecting splitter module 300 to the ONUs. Not all of the downstream ports of PON splitter 305 need to be used, of course, and in some non-typical instances the downstream PON transmission may be directed elsewhere. Splitter 305 may have any number of downstream ports, as represented by the ellipsis, although for simplicity only three ports are depicted in FIG. 3 (referred to as 306a, 306b, and 306n).

In this embodiment the downstream PON transmission received at the upstream port 304 of splitter 305 propagates from the downstream port 311 of WD 310. WD 310 separates the multiplexed transmission received at its upstream port 309. The multiplexed transmission is received, for example via feeder fiber 220 from CO 200 (see FIG. 2). It is presumed in this embodiment that the multiplexed transmission includes at least the downstream PON transmission and the IW transmission (when transmitted). The downstream PON transmission is forwarded to the PON splitter 305. The IW transmission is forwarded from port 312 of WD 310 to IW distributor 315.

In the embodiment of FIG. 3, IW distributor 315 receives the IW transmission from WD 310 and selectively distributes it to one or more of ports 316a, 316b, and 316n. Again, although only three such ports are depicted, there may be any number. Note that in most implementations, the IW transmission will be distributed to a single ONU at one time, though each accessible ONU may be sent the IW transmission in turn, or, for example, according to a pre-determined pattern or received instruction. In this embodiment, three splitter module ports are depicted, 325a, 325b, and 325n, though there could be any number. A splitter module port is associated with one access fiber that carries downstream transmissions to an ONU, although no specific physical configuration is implied. That is, there may be other components (not shown) on the transmission path between the splitter module and the access fiber.

In the embodiment of FIG. 3, splitter module ports 325a, 325b, and 325n, are respectively associated with a respective one of WM 320a, 320b, and 320n at their respective upstream ports WMs 321a, 321b, and 321n. Each of WMs 320a, 320b, and 320n in this embodiment multiplexes the downstream PON transmission received from splitter 305 at a respective one of WM ports 319a, 319b, and 319n and the IW transmission received from IW distributor 315 at a respective one of WM ports 318a, 318b, and 318n. Note that, as alluded to above, the IW transmission is typically not present at all times and on all ports; more likely it will be available for multiplexing at any one WM only occasionally. If there is no IW transmission present, the downstream PON transmission is simply allowed to propagate to the respective feeder fiber. Note also that other signals may in some cases be multiplexed at one or more of WMs 320a, 320b, or 320n, although that is not represented in FIG. 3.

Also depicted in FIG. 3 are the ONUs 335a, 335b, and 335n that are respectively associated with splitter module ports 325a through 325n and that communicate with the splitter module 300 via access fibers 330a through 330n.

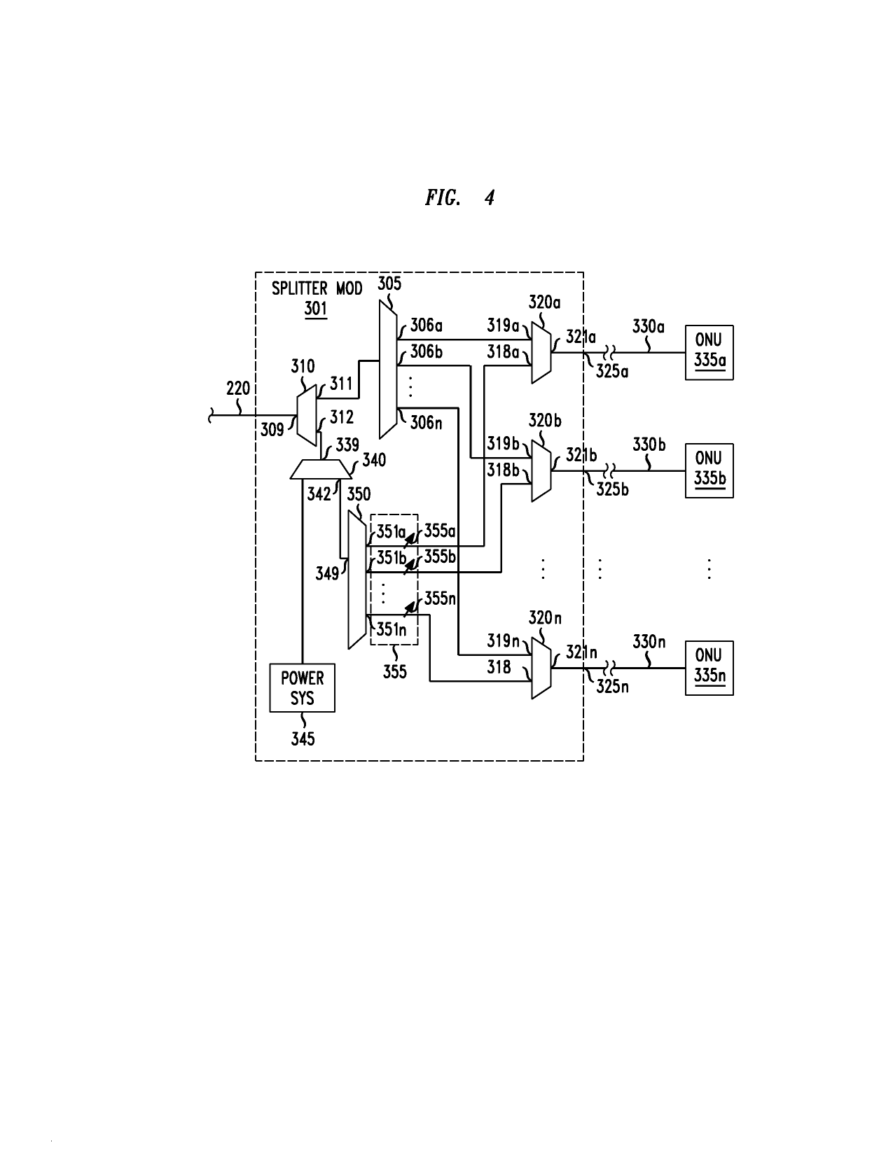

FIG. 4 is a simplified schematic diagram illustrating selected components of the splitter module 301 according to another embodiment of the present invention. Initially it is noted that some components of this embodiment are the same as those present in the splitter module 300 shown in FIG. 3. To the extent that the function of these components remains the same or similar from one embodiment to another, they are provided with identical reference numbers and may not be described again in reference to FIG. 4.

In the embodiment of FIG. 4, an IW splitter 350 distributes the IW transmission to a plurality of ports, represented here by ports 351a, 351b, and 351n. IW splitter 350 is an optical splitter that may be similar or identical in design to the PON splitter 305. The IW splitter 350 may be considered an IW distributor, though in this embodiment additional components are used in its implementation. IW splitter 350 receives an IW transmission at upstream port 349 from downstream port 342 of power tap 340. The upstream port of power tap 340, in turn, receives the IW transmission from downstream port 312 of WD 310, which as mentioned above, also distributes the downstream PON transmission to PON splitter 305.

In this embodiment, the IW transmission is provided with enough power so that a power system 345 may operate the optical switch array 355. Power tap 340 takes a portion of the power available from the IW transmission and provides it to power system 345. In this embodiment, power system 345 also includes a microcontroller (not separately shown) to allocate the power available at power system 345 to the selected switch or switches of switch array 355.

In the embodiment of FIG. 4, there is a switch 355a, 355b, 355n associated with each downstream port 351a, 351b, 351n of IW splitter 350, although strictly speaking it is not necessary that each port be switched. Although only three switches and downstream ports are depicted, there could be any number (as indicated by the ellipsis). The switches may be, for example, VOAs (variable optical attenuators) or MEMS (micro-electrical mechanical system) switches. They are typically though not necessarily identical to each other. The switches may be open or closed in a no-power state, and may be latched or unlatched. As mentioned above power for operating the switches is supplied by power system 345.

In operation, switch array 355 of FIG. 4 is therefore operable whenever an IW transmission it received at splitter module 301. IW splitter distributes the IW transmission at all ports 351a through 351n, and the appropriate switch or switches are set to permit the IW transmission to propagate to a respective upstream port 318a through 318n of WM 320a through 320n. At the WM, the IW transmission, if present, is multiplexed with the downstream PON transmission and propagates from one or more of downstream port 321a through 321n at splitter module ports 325a through 325n and along access fibers 330a through 330n to ONU 335a through 335n.

In a preferred embodiment, the IW transmission is sent to only one of WM 320a through 320n at any particular time, and of course there may be times when no IW transmission is present.

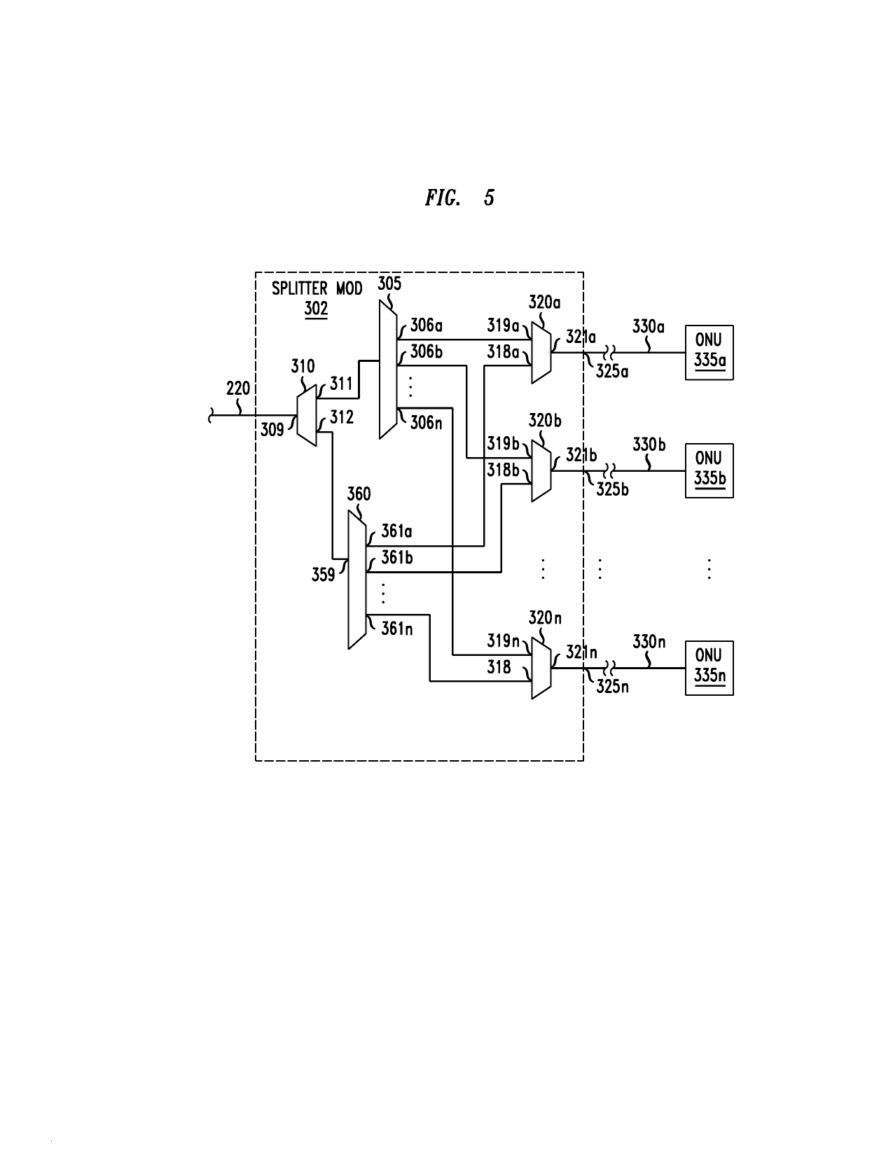

FIG. 5 is a simplified schematic diagram illustrating selected components of the splitter module 302 according to another embodiment of the present invention. Initially it is noted that some components of this embodiment are the same as those present in the splitter modules 300 and 301 shown in FIGS. 3 and 4, respectively. To the extent that the function of these components remains the same or similar from one embodiment to another, they are provided with identical reference numbers and may not be described again in reference to FIG. 5.

In the embodiment of FIG. 5, an AWG (arrayed waveguide grating) 360 distributes the IW transmission to one of the plurality of downstream ports 361a through 361n, with the port of distribution dependent on the wavelength of the received IW transmission at upstream port 359. In an alternate embodiment, AWG may be arranged to distribute a given wavelength to multiple downstream ports, although this is not expected in most implementations.

In the embodiment of FIG. 5, the IW transmission is then received at one of upstream ports 318a through 318n and multiplexed with the downstream PON transmission at a respective one of the WMs 320a through 320n. The multiplexed transmission then proceeds from one of the downstream ports 321a through 321n along one of access fibers 330a through 330n to ONU 335a through 335n.

As should be apparent, it is presumed in this embodiment that the IW may be generated at a variety of wavelengths, each of which may be associated with distribution of the IW transmission to a different port of the AWG. The variety of wavelengths may be produced, for example, by a tunable laser at the CO.

In an alternate embodiment (not shown), a fixed wavelength or tunable IW light generator may reside in the outside plant, for example in the FDH. This is not presently preferred.

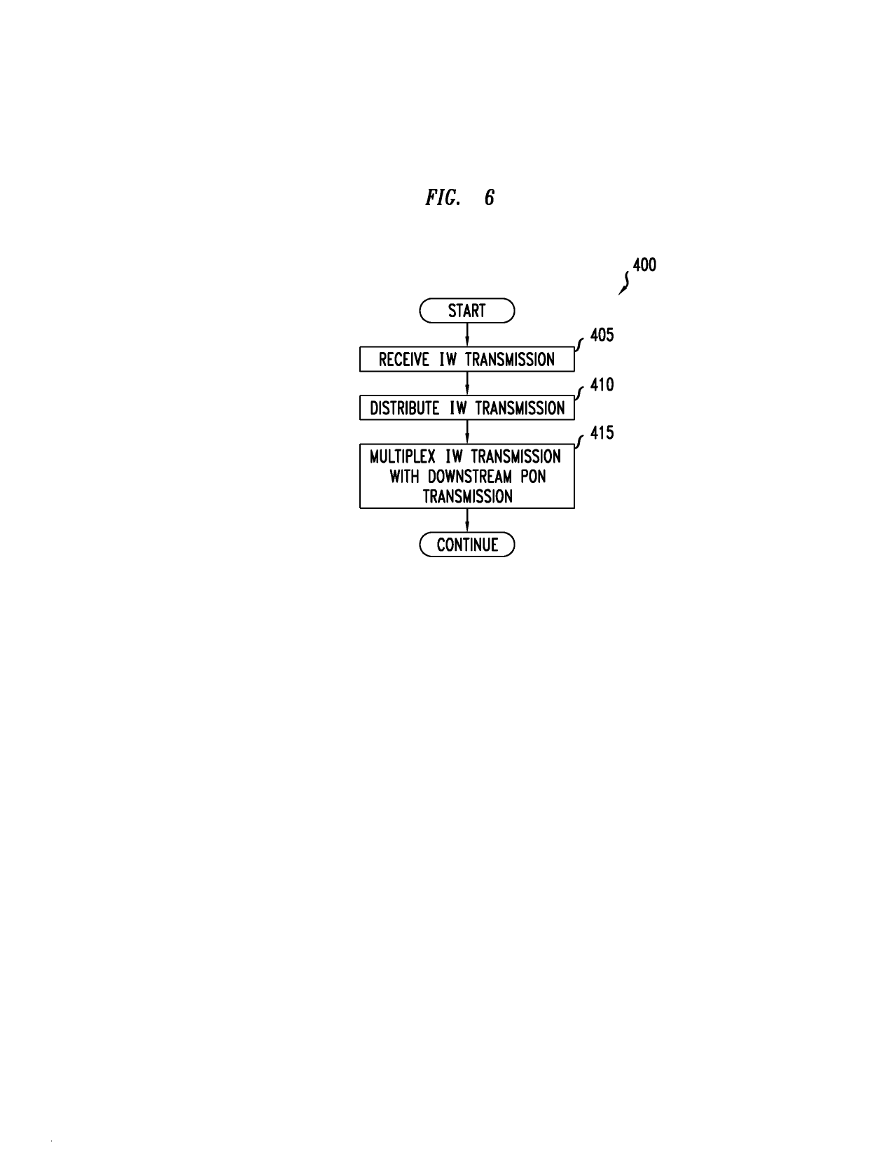

FIG. 6 is a flow diagram illustrating a method 400 according to an embodiment of the present invention. At Start is presumed that the components necessary to performing the method are available and operational according to this embodiment (see, for example, FIGS. 2 through 5). The process then begins with receiving an IW transmission (step 405). The IW transmission is then distributed (step 410) to at least one WM. The IW transmission is then multiplexed (step 415) with a downstream PON transmission. Note that this method may be performed, for example, in the IW module of a CO or in a splitter module such as one residing in a FDH. The process then continues as the IW transmission is selectively distributed to various ONUs.

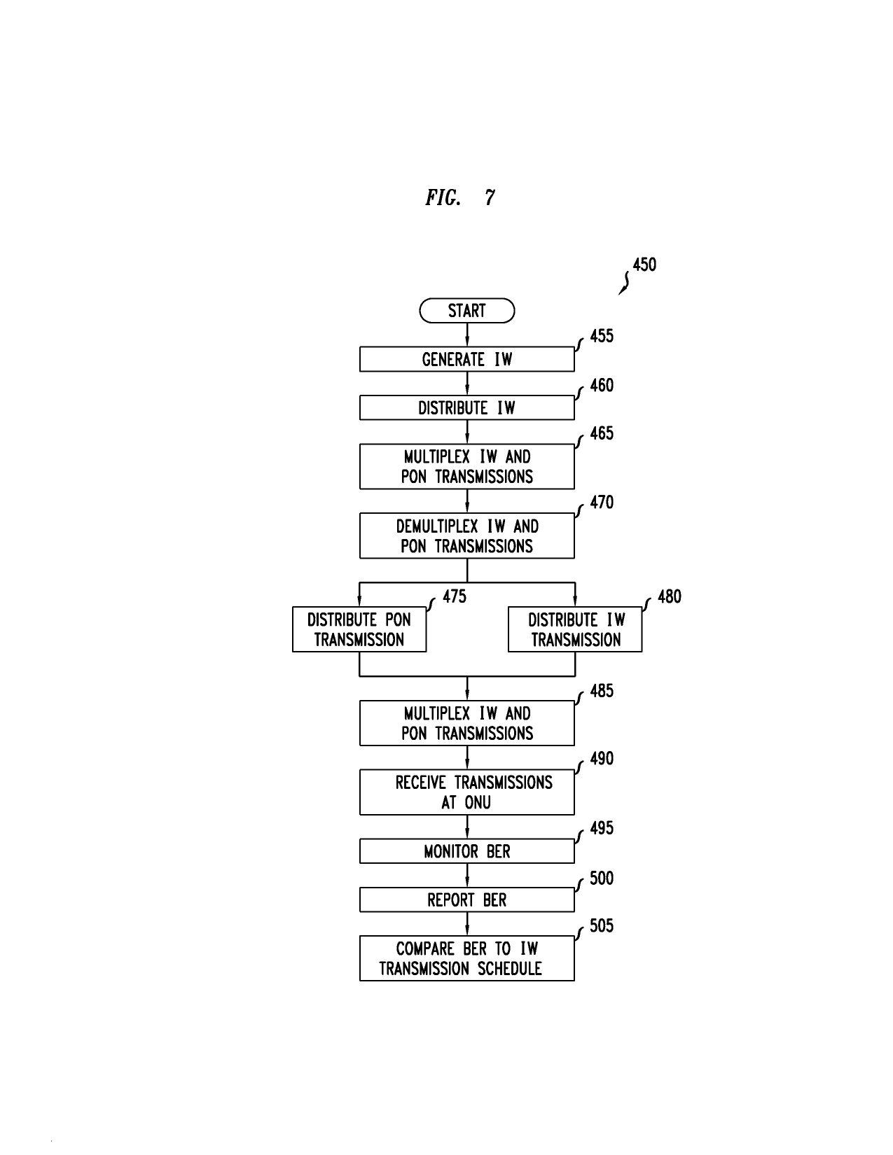

FIG. 7 is a flow diagram illustrating a method 450 according to another embodiment of the present invention. At Start is presumed that the components necessary to performing the method are available and operational according to this embodiment. The process then begins with generating an IW transmission (step 455) using an IW generator such as a laser or LED. In some embodiments, the IW generator is tunable while in others it is fixed as to wavelength. As one example, a fixed-wavelength laser light at approximately 1475 nm may be used in a PON that uses a wavelength of approximately 1480 to 1500 nm for regular downstream PON transmissions. The IW transmission wavelength could of course also be longer than that used for the downstream PON transmission. The exact IW selection will depend on the characteristics of the network where it is being implemented. In a preferred embodiment, the IW transmission is 3 to 6 dB higher than the level used for the downstream PON transmission.

In this embodiment, it is also presumed that the IW transmission is generated according to an IW transmission schedule. This schedule may be programmed, for example, by a network operator. The schedule may of course be adjusted for performing specific tasks or in response to changing network conditions. In some implementations, the IW transmission may be generated continuously, although this is not presently preferred. Where a tunable IW generator is used, the IW schedule also includes the times at which the various wavelengths are to be used. Note that in some cases, the IW schedule will also or instead include the times at which transmission have been made, rather than as a plan for generation.

In the embodiment of FIG. 7, the generated IE transmission is then distributed (step 460) to a WM for multiplexing (step 465) with a downstream PON transmission. Note that each IW generator may be associated with one or more WMs. If multiple WMs are served, then it is preferred that the IW transmission be distributed to only one WM at any given time. The multiplexed transmission then propagates from the CO along a feeder fiber (not separately shown) to a splitter module. The splitter module is frequently found in a FDH. At the splitter module, the IW transmission will be associated with a particular splitter port.

In the embodiment of FIG. 7, this association is accomplished by first de-multiplexing (step 470) the downstream transmission to segregate the IW transmission from the downstream PON transmission. The downstream PON transmission is then provided to a PON optical splitter for distribution (step 475) toward at least one, and usually a plurality of splitter ports. In a preferred embodiment, this includes providing the same downstream PON transmission to a plurality of WMs located within the FDH and considered part of the splitter module.

In this embodiment, the IW transmission segregated from the downstream transmission at step 470 is then selectively distributed (step 480) to one or more (and preferably only to one) of the WMs that are also recipients of the downstream PON transmission. As alluded to above, this distribution may be accomplished, for example, by employing a second optical splitter having switch-controlled outputs, or through an AWG or similar device that outputs different wavelengths of light to different ports. In the former case, instructions for effecting proper switch operation may be pre-programmed or transmitted from the CO to the splitter module, either in the IW transmission or otherwise. In the latter case, an output switch or switches may also be used to further aid in the distribution. As mentioned above, distribution switches and any controlling apparatus may be power from the IW transmission itself by using a power tap or similar device.

In embodiment of FIG. 7, the multiplexed downstream transmission then propagates along an access fiber to an ONU, where it is received (step 490) and processed according to normal procedures. The presence of the IW transmission in the received signal will, in most or all cases, result in a degradation of perceived transmission performance. Ideally, this effect is measurable without significantly affecting the subscriber experience. In a preferred embodiment, the BER is monitored to as an indicator of when an IW transmission is being received.

In this embodiment, the BER is monitored by the ONU (step 495), which regularly reports (step 500) this and perhaps other performance characteristics to the OLT at a time appropriate for upstream transmissions. The OLT or another device, usually one resident in the CO, then compares (step 505) the BER (or other) performance characteristics to the IW transmission schedule in an attempt to determined when a particular splitter port was used in the transmission of the IW transmission to the reporting ONU. Note that the process may be repeated more than once to provide greater confidence that a correct association has been made.

Note that the sequences of operation illustrated in FIGS. 6 and 7 represent exemplary embodiments; some variation is possible within the spirit of the invention. For example, additional operations may be added to those shown in FIGS. 6 and 7, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. A splitter module for a PON (passive optical network), comprising:
an optical splitter;
an IW (interfering wavelength) distributor;
at least one WM (wavelength multiplexor) optically connected to and downstream of the optical splitter and the IW distributor.

2. The splitter module of claim 1, further comprising an IW source.

3. The splitter module of claim 1, wherein the IW distributor comprises an AWG having a plurality of output ports.

4. The splitter module of claim 1, wherein the IW distributor comprises a second optical splitter having a plurality of output ports.

5. The splitter module of claim 4, further comprising at least one optical switch associated with an output port of the plurality of output ports.

6. The splitter module of claim 1, further comprising a power system coupled to a power tap.

7. The splitter module of claim 6, further comprising a switch array downstream of the IW distributor and powered by the power system.

8. The splitter module of claim 1, further comprising a WD (wavelength de-multiplexor) optically connected to and upstream of the optical splitter and the IW distributor.

9. An IW module for a PON, comprising:
program instructions embodied in a non-signal memory device that when executed causes an IW generator to generate an IW transmission; and
a multiplexor for multiplexing the IW transmission with a downstream PON transmission.

10. The IW module of claim 9, further comprising the IW generator.

11. The IW module of claim 9, wherein the IW generator is a tunable laser.

12. The IW module of claim 9 further comprising a controller for executing program instructions stored on the memory device.

13. The IW module of claim 9, further comprising an IW table for recording an IW transmission schedule associating IW transmissions with splitter ports.

14. The IW module of claim 9, further comprising program instructions stored on the memory device that when executed compare the IW transmission schedule to at least one received ONU performance characteristic.

15. The IW module of claim 14, wherein the at least one ONU performance characteristic is BER (bit error rate) performance.

16. A method of identifying splitter ports in a PON, comprising:
receiving an IW transmission;
distributing the IW transmission to at least one WM; and
multiplexing the IW transmission with a downstream PON transmission.

17. The method of claim 16, further comprising generating the IW transmission.

18. The method of claim 16, further comprising receiving at least one ONU performance characteristic.

19. The method of claim 18, further comprising comparing an IW transmission schedule to the at least one received ONU performance characteristic.

20. The method of claim 19, further comprising associating the at least one ONU performance characteristic with a splitter port.

21. The method of claim 16, further comprising receiving an IW transmission schedule for controlling the operating of the switch array.

22. The method of claim 16, further comprising reporting by the ONU of at least one performance characteristic.
